(19) United States
(12) Patent Application Publication
(10) Pub. No.: US 2001/0011244 A1
(43) Pub. Date: Aug. 2, 2001

(54) Cotton trading forum

(76) Inventor: Bruce Evans, Poole (GB)

Correspondence Address: Ira S. Dorman, Suite 200, 330 Roberts Street, East Hartford, CT, 06108, US

(21) Appl. No.: 09/767,969

(22) Filed: Jan. 23, 2001

(30) Foreign Application Priority Data
Jan. 28, 2000 (GB) 00 01 882.0

(51) Int. Cl. G06F 17/60

(52) U.S. Cl. 705/37; 705/26

(57) ABSTRACT

Data processing apparatus which is particularly adapted to facilitate trading in raw cotton includes a buyers register and a sellers register. Registered sellers submit details of raw cotton which they have available for sale and registered buyers submit purchase offers. The purchase offers are matched with the cotton which is for sale and the sellers offer with the lowest asking price is selected and a purchase proposal is generated. The proposal can be accepted or rejected by the buyer, who also has the option of submitting a counter-proposal. When an offer is accepted, subject to a biometric security check, a contract is electronically generated and exchanged between the parties so that the entire process may be concluded without human intervention. The trading process is simplified, is carried out quickly and efficiently, and costs are reduced.

### TECHNICAL FIELD OF THE INVENTION

This invention relates to novel data processing apparatus which facilitates the trading of raw cotton.

### BACKGROUND

The annual market in raw cotton is currently valued at about 34,000 million US dollars, but the method of trading has changed little for centuries. The grower sells to a processor (known as a ginner) who then sells to merchants who, in turn, sell on to the users, namely spinners. Cotton may pass through the hands of several merchants in a number of countries before finally reaching a spinner. Since each transaction is handled by a network of agents who each take a fee, the chain is very protracted and costs are relatively high.

An important function of cotton merchants has traditionally been seen as providing a buffer between growers or ginners and the users, which reduces the risks inherent in selling a product which is subject to worldwide price fluctuations. However, in recent years a few powerful cotton merchants have increasingly come to dominate the international cotton market. There have been take-overs and mergers whilst many small or medium-sized companies have gone out of business. The dominance of the major traders and the complex agent network means that there now exists the capacity to manipulate the market in the short term to the detriment of both growers and spinners. In short, the system has become opaque.

The present invention seeks to provide a new and inventive data processing system which facilitates trading in raw cotton in such a way that it redresses the balance in favour of growers and spinners and permits the trading process to be conducted quickly and efficiently.

### SUMMARY OF THE INVENTION

The present invention proposes data processing apparatus for use in the trading of raw cotton which includes:

a buyers register for holding details of raw cotton buyers;

a sellers register for holding details of raw cotton sellers;

means for electronically receiving, via a secure connection, details from registered sellers relating to raw cotton which they have available for sale and an asking price;

means for storing said details received from registered sellers;

means for electronically receiving from registered buyers, via a secure connection, offers to purchase raw cotton, said offers including details of their requirements and an offer price;

means for storing said received offers to purchase;

means for matching the stored offers to purchase with the stored details received from registered sellers and selecting the matched offer with the lowest asking price;

means for generating a proposal for purchase based on said selected offer, including the respective asking price, and electronically transmitting said proposal to the buyer; and

means for electronically receiving an acceptance or refusal of said proposal and communicating an acceptance electronically to the buyer.

Market conditions can change extremely quickly, and in a busy trading environment multiple buyers and sellers offers may be submitted in a very short period of time. With the present invention the processing apparatus is utilised to optimum efficiency, response time is optimised, and the whole transaction can be concluded quickly and efficiently with minimum risk of errors. Thus, leaving aside the fact that the invention facilitates trading in raw cotton and will usually (but not necessarily) be implemented in computer software, the invention provides novel data processing apparatus which operates to produce a new technical result. The invention therefore follows the established principle that data processing apparatus which operates in a new way constitutes patentable subject matter as set out in Genentech Inc.'s Patent, [1989] RPC 147. The invention further follows Viacom Systems Inc.'s Application (EPO Technical Board of Appeal Decision T208/84) which confirmed that apparatus operating to produce a new technical result is patentable subject matter. Moreover, the invention is distinguished from Merrill Lynch's Application [1989] RPC 561 wherein the claimed data processing system made no technical contribution to the known art.

In the present context a secure connection is one which cannot be accessed by the general public, e.g. is password protected.

With the advent of IBM compatible personal computers (PCs), computers have become very common in the home and workplace. Networks have been developed that allow information and data to be shared between users throughout the world. Developments in communication software protocols (programs that are essentially a combination of smaller program units) have enabled different networks and less common computer to communicate with each other using a common machine language such as TCP/IP (Transmission Control Protocol / Internet Protocol). Centralising resources and information helps to free users machines (known as clients) from processes and jobs that would normally tie up the client machine for extended periods of time. Such centralised computers are commonly known as servers. Virtual servers may handle multiple web sites, e. mail, NNTP news feeds, file storage, user authentication, chat rooms, FTP sites, domain name servers and their associated top level name servers. The data processing system of the present invention is preferably provided by such a web server.

The cotton trading forum which is embodied in the data processing apparatus operates on a different basis to traditional merchants. The operators of the forum act as passive intermediaries between the buyers and sellers and never take ownership of the goods. The invention could, but does not necessarily, eliminate the requirement for cotton merchants since the cotton sellers could be growers, ginners or merchants. Similarly, the potential buyers could be merchants or spinners.

In order to use the trading forum the buyers may be required to pay an annual registration fee to the site operators. Sellers may pay a userfee on sales, e.g. 1.5% of the agreed selling price.

The details submitted by buyers will normally include the quantity of raw cotton which they wish to purchase, information about the nature of the cotton which they require, and an opening offer price which they are prepared to pay. This price is subject to negotiation and may be lower than the price which they eventually agree. Sellers submit details of the kind and quantity of raw cotton which is available for sale and an offer price which they would like to obtain. Again, this might be higher than the finally agreed figure. The submitted details are not necessarily published within the forum so that they are available for buyers or sellers to study, but if they are the identity of the buyer or seller is withheld to reduce the risk of bypassing the system.

Although the cotton trading forum could be operated by manually matching the buyers requirements with the sellers details the speed and efficiency of processing the information is increased if the apparatus includes means for automatically comparing and matching the buyers and sellers details. This can be achieved using an operators computer which receives and processes the details submitted via a host server. At this stage in the process the offer prices are not taken into account, but once an offer to buy has been matched with one or more offers to sell the offer with the lowest selling price is selected (assuming that more than one offer to sell has been matched). The selected offer is then forwarded electronically to the buyer. The buyer can then reject or accept an offer, an acceptance being transmitted electronically to the seller. If the offer is rejected the seller is preferably notified so that the seller has an opportunity to submit a revised (lower) asking price, which the buyer can again accept or reject. The buyer may also submit a counter offer for consideration by the seller, which he can again accept or reject. This process of offer and counter offer may be repeated several times until agreement is reached.

The identity of the two parties is only revealed to each other after a deal is concluded.

Because of the low operating overheads and lower risk associated with the operation of the trading forum as compared with the activities of a cotton merchant, the user fee charged on concluded sales can be significantly lower than the margins that are traditionally gained by merchants. The user fee will normally be paid after shipment of the goods has taken place and simultaneously with the payment made to the seller.

For the first time in the history of raw cotton trading the invention opens up the possibility of global, 365 days, 24 hour, 7 days a week trading.

Thus, for example, a grower in the United States who has a quantity of cotton for sale can submit details to the forum. During the night, when no business is normally being conducted in the United States, a Japanese spinner can electronically submit an offer to purchase a quantity of cotton. If the offer price meets the asking price the offer can be accepted automatically and contracts exchanged electronically. A deal can therefore be concluded almost instantaneously outside normal business hours with no requirement for manual intervention.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a schematic diagram showing a small representative part of an Internet infrastructure which, in accordance with the invention, hosts a raw cotton trading forum;

FIG. 2 is a diagrammatic representation of the main units of the data processing apparatus forming part of the infrastructure which implements the trading forum;

FIG. 3 is a simplified flow diagram demonstrating the main features of the trading forum; and

FIG. 4 is an illustrative page from the forum.

### DETAILED DESCRIPTION OF THE DRAWINGS

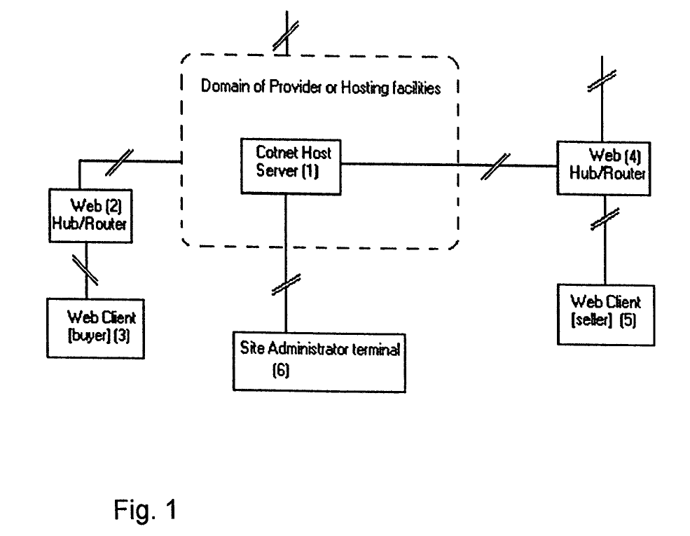

FIG. 1 diagrammatically illustrates the infrastructure of the Internet. The lineswith double slashes represent connections that cover distances greater than a Local Area Network (LAN), which could be connections via underseas telecommunications lines satellite links, or conventional terrestrial communication lines. The area indicated in dashed outline represents the LAN of a host provider (e.g. an Internet Service Provider or managed network) within which a server 1 resides. Communications via the Internet are usually relayed from provider to provider using the connections mentioned, so that often there may not be any direct connection between two computers which pass data between each other. All of the communications are encrypted using the most up-to-date methods and software.

The Cotton Net trading forum to be described by way of example is embodied in a web site hosted on the web server 1 which is linked to hubs and routers or similar equipment that provides connectivity to the Internet, two of which are illustrated at 2 and 4 by way of example. The web site contains a number of pages written in PHP and Javascript which then translates into HTML (HyperText Markup Language) for viewing by Internet browers such as Internet Explorer or Netscape Navigator. The pages can thus be downloaded and executed on clients machines, examples of which are indicated at 3 and 5. Users can move from page to page as desired. Some of the pages contain forms which can be completed by users and the details which are entered can be electronically submitted to the server 1 where they can be stored within a database until they are referenced by a computer 6 controlled by the web site operator.

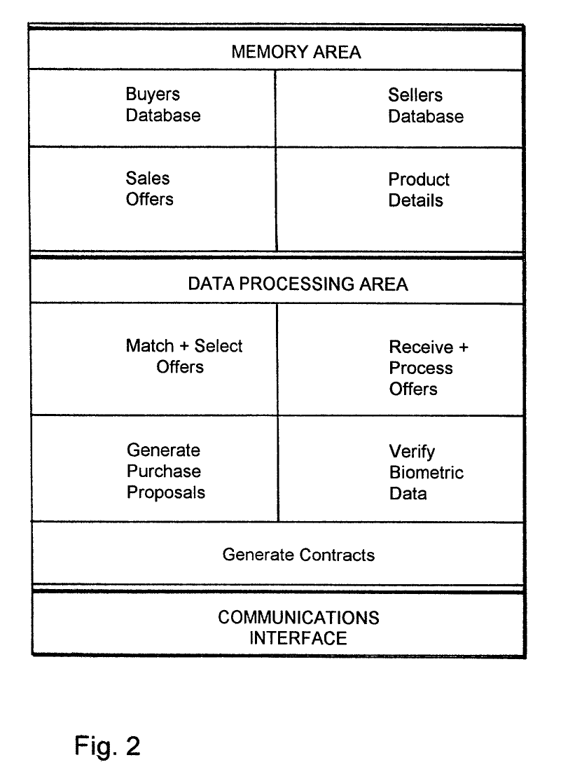

FIG. 2 shows the main areas of the server 1, which includes a storage areas, a data processing area and a communications interface.

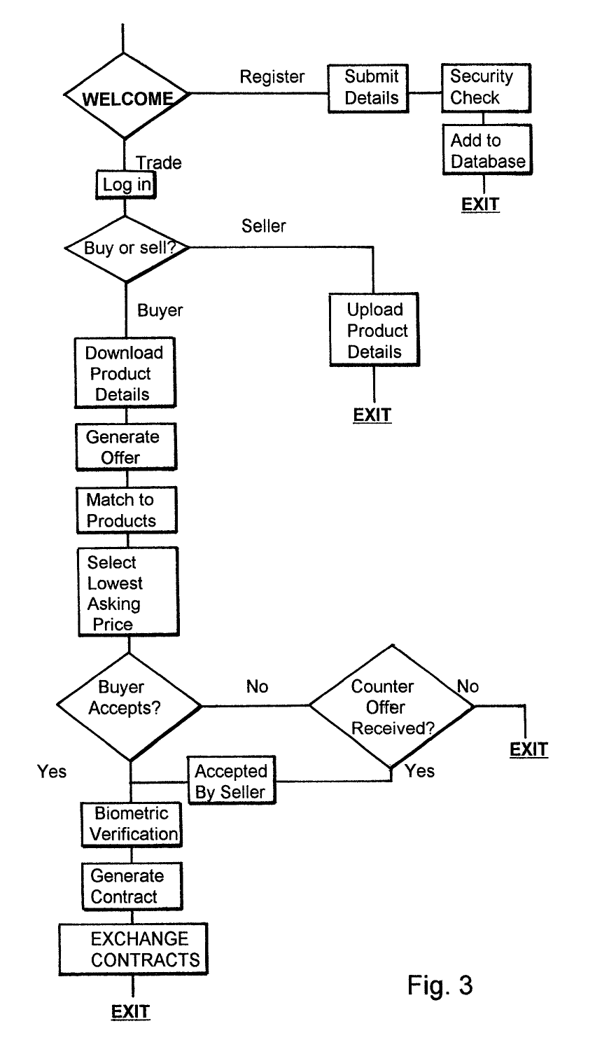

FIG. 3 shows a simplified flow diagram illustrating how the forum may operate. Visitors arriving at the Cotton Net forum are greeted by a home page which welcomes them to the site and explains the merits of the Cotton Net trading forum. The home page may also carry short items of news relevant to the raw cotton market and might also carry advertisements, e.g. for shipping companies or quality control companies operating in the raw cotton sector.

Buyers or sellers who wish to use the service can use a hypertext link to move to a sign-up page which typically gives Terms and Conditions of the service. Buyers of raw cotton are charged a fixed annual registration fee for using the service, but sellers are allowed free use subject to a user fee on concluded sales which is payable to the service operator, e.g. 1.5% of the total value of a sale. A form contains blank boxes which can be completed by a prospective user (buyer or seller), such as name, address and contact details, including a valid e.mail address. Users are also required to submit biometric data for verification of future transactions using a finger print scanner. Facial biometrics could also be submitted using a web cam, for example. The details are then submitted electronically to the server where they are stored in a buyer or seller database and forwarded to the service operators computer 6. When the operator receives the details, subject to any security checks, the user is allocated a password and unique user name which are sent to the user by e.mail. This process could be automated if desired. A valid password and user name are required for access to the trading floor, and users are also required to possess a security scanner for acknowledgement of transactions. The scanner is used to provide the final authorisation from a user to conclude the transaction with another party.

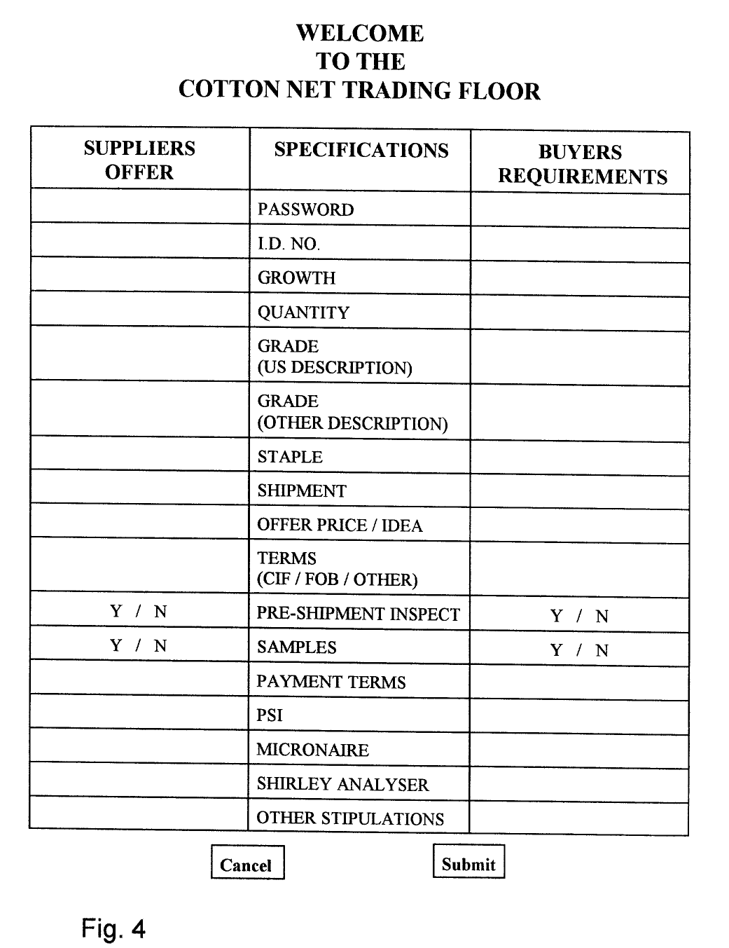

Another page, or group of pages, provide the main area of the raw cotton trading forum, known as the trading floor. In order to give a flavour of what is currently being traded the trading floor could carry a selection of requests from buyers and offers of raw cotton which sellers have available for sale without actually identifying the buyers or sellers. Transactions are conducted by downloading and completing a virtual trading form, such as is shown in FIG. 4. The form contains a number of fields for users to complete before the form is electronically submitted. One section of the form, shown on the right, allows buyers to enter their requirements, including the price which they are willing to pay. Another section, shown on the left, can be completed by a grower or other seller to provide details of a quantity of raw cotton which they have available for sale. Again, a preliminary asking price can be entered.

Provided a valid password and user name have been included on the form, the details which are electronically transmitted are stored by the server 1 which, under the control of suitable software, attempts to match one or more offers of sale to a buyers request. An attempt is made to match all of the product details except for the price, which is negotiable. If a number of matches are produced the sales offer with the lowest asking price is selected and used to generate a purchase proposal which includes all details except for anything which might serve to identify the potential seller. The proposal is then electronically transmitted to the buyer using e.mail who is invited to respond to either accept the offer, reject it or counter with a lower price. The seller is notified of an accepted offer, again using e.mail, or if a counter offer has been made a counter-proposal is generated and forwarded to the seller for consideration. The seller can also submit a revised asking price if they wish. The process of offer and counter offer can be repeated a number of times until agreement is finally reached.

It should be noted that thus far the buyer and seller have not communicated directly with each other. All communications are routed to the server 1, which then, preferably without human intervention, forwards the contents to the other party. The identity of the two parties is only revealed to each other when an offer or counter offer has been accepted. To prevent fraud the server only accepts confirmation of an agreement when both parties acknowledge using a biometrics security scanner or any other high level security device. Contracts are then generated by the server and exchanged electronically, with confirmation by hard copy documentation sent via the postal system. Only when this has been completed is a legally binding contract made.

When the goods have been shipped by the seller and payment has been received, e.g. by cashing a letter of credit, the user fee becomes due to the forum operator.

If a buyer or seller should default on a contract, e.g. by failing to make a shipment, by mis-describing the goods, or by failing to make a payment which is due to the buyer or site operator, the party can be excluded from Cotton Net by revoking the password and user name of the account. The identity of the party and default details can also be circulated to other members and/or posted to the web site to serve as a warning that they are not trustworthy.

It will thus be appreciated that the trading process can be fully automated so that members in any part of the world can make offers and conclude sales 24 hours a day, 365 days a year. Growers receive a better price than they would normally receive while the spinners pay less and no longer need to carry large stocks to protect themselves against shortages and price fluctuations. The increased transaction speed greatly reduces the risk associated with international cotton price fluctuations, and there is greater transparency in transactions providing a better deal for growers and users.

It will be appreciated that the features disclosed herein may be present in any feasible combination. Whilst the above description lays emphasis on those areas which, in combination, are believed to be new, protection is claimed for any inventive combination of the features disclosed herein.

1. Data processing apparatus for use in the trading of raw cotton which includes:
a buyers register for holding details of raw cotton buyers;
a sellers register for holding details of raw cotton sellers;
means for electronically receiving, via a secure connection, details from registered sellers relating to raw cotton which they have available for sale and an asking price;
means for storing said details received from registered sellers;
means for electronically receiving from registered buyers, via a secure connection, offers to purchase raw cotton, said offers including details of their requirements and an offer price;
means for storing said received offers to purchase;
means for matching the stored offers to purchase with the stored details received from registered sellers and selecting the matched offer with the lowest asking price;
means for generating a proposal for purchase based on said selected offer, including the respective asking price, and electronically transmitting said proposal to the buyer; and
means for electronically receiving an acceptance or refusal of said proposal and communicating an acceptance electronically to the buyer.

2. Data processing apparatus according to claim 1, in which said proposal does not identify the seller and said acceptance or refusal does not identify the buyer.

3. Data processing apparatus according to claim 1, including means for electronically generating and exchanging contracts between the buyer and seller.

4. Data processing apparatus according to claim 1, including means for retrieving said stored details received from sellers and electronically sending them to registered buyers.

5. Data processing apparatus according to claim 1, including means for retrieving said stored offers to purchase and electronically sending them to registered sellers.

6. Data processing apparatus according to claim 1, in which the buyers requirements include details of the kind of cotton they require.

7. Data processing apparatus according to claim 1, in which the buyers requirements include details of the quantity of raw cotton which they require.

8. Data processing apparatus according to claim 1, in which the buyers and sellers registers include biometric verification data and the apparatus includes means for receiving and verifying biometric details from the buyer and seller against the biometric information held in the database.
